(19) United States
(12) Patent Application Publication
(10) Pub. No.: US 2019/0222076 A1
(43) Pub. Date: Jul. 18, 2019

(54) ELECTRIC MACHINE INCLUDING MAGNETS HAVING DIFFERENT MAGNETIC CHARACTERISTICS

(71) Applicant: OTIS ELEVATOR COMPANY, Farmington, CT (US)

(72) Inventors: Jagadeesh K. TANGUDU, South Windsor, CT (US); Beata I. WAWRZYNIAK, South Windsor, CT (US)

(21) Appl. No.: 15/871,362

(22) Filed: Jan. 15, 2018

(51) Int. Cl. H02K 1/27; H02K 21/14; H02K 15/03; H01F 13/00; H02K 1/24

(52) U.S. Cl. CPC H02K 1/2766; H02K 21/14; H02K 1/246; H01F 13/003; H02K 15/03

(57) ABSTRACT

An illustrative example machine includes a rotatable body and a plurality of magnetic poles supported by the rotatable body. Each of the plurality of magnet poles comprises a plurality of magnet segments. A first magnet segment of each of the magnet poles has a first magnetic characteristic that affects a magnetic flux associated with the respective magnet pole in a first way. A second magnet segment of each magnet pole has a second magnetic characteristic that affects the magnetic flux associated with the respective magnet pole in a second way. The first magnetic characteristic is different than the second magnetic characteristic and the first way in which the different magnet segments affect the magnetic flux is different than the second way.

### BACKGROUND

Electric motors have a variety of uses. Some electric motors include permanent magnets supported on the rotor. The magnets are arranged to achieve a desired machine performance, such as torque at a required speed, based on a given input voltage and current. A variety of different magnet configurations have been proposed.

One issue associated with some known electric motors is the cost of the materials for the magnets. Achieving appropriate magnet strength and magnetic flux sometimes requires relatively expensive magnet components.

### SUMMARY

An illustrative example machine includes a rotatable body and a plurality of magnetic poles supported by the rotatable body. Each of the plurality of magnet poles comprises a plurality of magnet segments. A first magnet segment of each of the magnet poles has a first magnetic characteristic that affects a magnetic flux associated with the respective magnet pole in a first way. A second magnet segment of each magnet pole has a second magnetic characteristic that affects the magnetic flux associated with the respective magnet pole in a second way. The first magnetic characteristic is different than the second magnetic characteristic and the first way in which the different magnet segments affect the magnetic flux is different than the second way.

In an example embodiment having one or more features of the machine of the previous paragraph, the first magnetic characteristic comprises a first magnet strength and the second magnetic characteristic comprises a second magnet strength.

In an example embodiment having one or more features of the machine of any of the previous paragraphs, the first magnetic characteristic comprises a first magnet thickness and the second magnetic characteristic comprises a second magnet thickness.

In an example embodiment having one or more features of the machine of any of the previous paragraphs, the first magnet strength is greater than the second magnet strength and the first way that the first magnet strength affects the magnetic flux comprises establishing a first magnetic flux density at a location of the first magnet segment. The second way that the second magnet strength affects the magnetic flux comprises establishing a second magnetic flux density at a location of the second magnet segment. The first magnetic flux density is greater than the second magnetic flux density.

In an example embodiment having one or more features of the machine of any of the previous paragraphs, the first magnetic characteristic comprises a first magnet thickness, the second magnetic characteristic comprises a second magnet thickness and the first magnet thickness is greater than the second magnet thickness.

In an example embodiment having one or more features of the machine of any of the previous paragraphs, the magnet segments are supported on an exterior of the rotatable body, the rotatable body includes at least one recess configured to receive a portion of the first magnet segment and an outer surface of the first and second magnet segments are equally spaced from a center of the rotatable body.

In an example embodiment having one or more features of the machine of any of the previous paragraphs, the magnet segments are supported on an exterior of the rotatable body and an outer surface of the first and second magnet segments, respectively, are at different distances from a center of the rotatable body.

In an example embodiment having one or more features of the machine of any of the previous paragraphs, the magnet segments are received at least partially within the rotatable body.

In an example embodiment having one or more features of the machine of any of the previous paragraphs, each magnet pole comprises a third magnet segment having a third magnetic characteristic that affects a magnetic flux associated with the corresponding magnet pole in a third way. The third magnetic characteristic is different than the first and second magnetic characteristics, respectively, and the third way is different than the first and second ways, respectively.

In an example embodiment having one or more features of the machine of any of the previous paragraphs, the machine comprises an electric motor having a stator and a rotor and the rotatable body is the rotor of the electric motor. In an example embodiment having one or more features of the machine of any of the previous paragraphs, the first magnetic characteristic comprises a first magnetization direction and the second magnetic characteristic comprises a second magnetization direction.

In an example embodiment having one or more features of the machine of any of the previous paragraphs, the first magnetic characteristic comprises at least two of a first magnet strength, a first magnet thickness and a first magnetization direction and the second magnetic characteristic comprises at least two of a second magnet strength, a second magnet thickness and a second magnetization direction.

In an example embodiment having one or more features of the machine of any of the previous paragraphs, the rotatable body has an axis of rotation and the magnet segments are at least partially oriented at an oblique angle relative to the axis of rotation.

In an example embodiment having one or more features of the machine of any of the previous paragraphs, the magnet segments of the plurality of poles are arranged in a Halbach array.

An illustrative example method of making a machine, which has a plurality of magnet poles on a rotatable body with a plurality of magnet segments for each of the magnet poles, includes situating the plurality of magnet segments of each of the plurality of magnet poles on the rotatable body so that a first magnet segment of each of the magnet poles has a first magnetic characteristic that affects a magnetic flux associated with the respective magnet pole in a first way and a second magnet segment of each of the magnet poles has a second magnetic characteristic that affects the magnetic flux associated with the respective magnet pole in a second way. The first magnetic characteristic is different than the second magnetic characteristic and the first way is different than the second way.

In an example embodiment having one or more features of the method of the previous paragraph, the first magnetic characteristic comprises a first magnet strength and the second magnetic characteristic comprises a second magnet strength.

In an example embodiment having one or more features of the method of any of the previous paragraphs, the first magnetic characteristic comprises a first magnet thickness and the second magnetic characteristic comprises a second magnet thickness.

In an example embodiment having one or more features of the machine of any of the previous paragraphs, the first magnetic characteristic comprises a first magnetization direction and the second magnetic characteristic comprises a second magnetization direction.

In an example embodiment having one or more features of the machine of any of the previous paragraphs, the first magnetic characteristic comprises at least two of a first magnet strength, a first magnet thickness and a first magnetization direction and the second magnetic characteristic comprises at least two of a second magnet strength, a second magnet thickness and a second magnetization direction.

In an example embodiment having one or more features of the machine of any of the previous paragraphs, the first way that the first magnetic characteristic affects the magnetic flux comprises establishing a first magnetic flux density at a location of the first magnet segment, the second way that the second magnetic characteristic affects the magnetic flux comprises establishing a second magnetic flux density at a location of the second magnet segment, and the first magnetic flux density is greater than the second magnetic flux density.

The various features and advantages of at least one disclosed example embodiment will become apparent to those skilled in the art from the following detailed description. The drawings that accompany the detailed description can be briefly described as follows.

### BRIEF DESCRIPTION OF THE DRAWINGS

FIG. 1 schematically illustrates an electric machine designed according to an embodiment of this invention.

FIG. 2 schematically illustrates an example arrangement of magnet segments of an example magnet pole according to an embodiment of this invention.

FIG. 3 schematically illustrates another example arrangement of magnet segments.

FIG. 4 schematically illustrates another example arrangement of magnet segments.

FIG. 5 schematically illustrates another example arrangement of magnet segments.

FIG. 6 schematically illustrates another example arrangement of magnet segments.

FIG. 7 schematically illustrates another example arrangement of magnet segments.

FIG. 8 schematically illustrates another example arrangement of magnet segments.

FIGS. 9A and 9B schematically illustrate how an example arrangement of magnet segments affects a flux profile.

FIGS. 10A and 10B schematically illustrate how another example arrangement of magnet segments affects a flux profile.

FIGS. 11A and 11B schematically illustrate how another example arrangement of magnet segments affects a flux profile.

FIG. 12 schematically illustrates an elevator system including an electric machine designed according to an embodiment of this invention.

FIG. 13 schematically illustrates another example electric machine embodiment.

FIG. 14 schematically illustrates a feature of some example embodiments.

### DETAILED DESCRIPTION

FIG. 1 schematically shows an electric machine 20 including a stationary body 22 and a rotatable body 24. In this example, the stationary body 22 is a stator and the rotatable body 24 is a rotor. The electric machine 20 operates as an electric motor in some embodiments. In other embodiments, the electric machine 20 operates as a generator. Some uses of an electric machine designed according to an embodiment of this invention includes selectively operating the machine as a motor or a generator.

The rotatable body 24 includes a plurality of magnet poles 26 that each include a plurality of magnet segments. In this example, each magnet pole 26 includes at least one first magnet segment 30, at least one second magnet segment 32, and at least one third magnet segment 34. Each of the magnet poles 26 in this example includes a single third magnet segment 34, two second magnet segments 32, and two first magnet segments 30. A retaining wrap or ring 36 retains the magnet segments in place on the rotatable body 24 in a generally known manner during machine operation. The retaining wrap may comprise carbon fiber, an alloy, or a metallic sleeve.

Each of the magnet segments has a magnetic characteristic that affects the magnetic flux associated with the respective pole 26. Various different magnetic characteristics are included in different embodiments. For example, the magnetic characteristic in some embodiments includes the size of the magnet segments. Different magnet sizes can have different impacts or influences on the flux. Other embodiments include a maximum energy product or magnet performance (i.e., MGOe) as the magnetic characteristic that is different among magnet segments. The magnetization direction is another magnetic characteristic that differs among magnet segments in the poles of some embodiments. At least some embodiments include at least two of the MGOe, magnet size and magnetization direction as part of the magnetic characteristic that differs among at least two of the magnet segments of each pole.

In the illustrated example of FIG. 1, the first magnet segments 30 have a first magnetic characteristic that comprises the MGOe. The second magnet segments 32 have a second magnetic characteristic comprising a second magnet performance. In this example, the second magnet performance of the second magnet segments 32 is lower or weaker than the first magnet performance of the first magnet segments 30. The third magnet segments 34 in this example have a third magnetic characteristic comprising a third magnet performance. The third magnet performance in this example is the lowest or weakest of the three magnetic characteristics.

Each pole 26 has a plurality of magnet segments with different magnetic characteristics to achieve a desired performance of the machine 20. For example, the first magnet segments 30 having a larger maximum energy product affect magnetic flux by concentrating more of the magnetic flux at the location of the first magnet segments 30 compared to the amount of magnetic flux concentration at the locations of the second magnet segments 32 and the third magnet segments 34 of the respective poles 26. Selecting different magnet segments of different magnetic characteristics and arranging them in different ways provides different machine performance capabilities. The magnetic characteristics and the arrangement of the respective magnet segments can be varied to achieve a desired air gap flux density shape allowing electric machine manufacturers more flexibility.

Another feature associated with utilizing different magnet segments having different magnetic characteristics is that it is possible to filter out or smooth out spikes in the magnetic flux pattern that otherwise may occur at interfaces among different magnet pieces. Maintaining an inventory of a variety of magnet segment types makes customizing a machine 20 more economical with fewer types of rotor and stator designs, for example.

Utilizing different magnet segments having different magnetic characteristics also allows for reducing the cost of the machine. In locations where high strength magnets are not required, it is possible to utilize ceramic or ferrite magnets or recycled magnets. Other magnet segments may comprise rare earth magnet materials to provide higher strength at the locations of each pole where the higher strength is required. Other example magnet materials that are useful in embodiments of this invention include NdFeB, SmCo and AlNiCo. Given this description, those skilled in the art will be able to select appropriate magnet materials and appropriate magnetic characteristics to achieve a desired result.

FIG. 2 illustrates another example arrangement of a magnet pole 26 including first magnet segments 30, second magnet segments 32 and a third magnet segment 34. In this example, the magnetic characteristic comprises a magnet thickness and the first magnet segments 30 have a greater thickness than that of the second magnet segments 32 and the third magnet segment 34. Even though the first magnet segments 30 have a greater thickness and the magnet segments are received on an exterior surface of the rotatable body 24, the outer or exterior surface of all of the magnet segments are equally spaced from a center 40 of the rotatable body 24. Notches or recesses 42 are provided on the exterior of the rotatable body 24 and a portion of the first magnet segments 30 are received in those recesses 42.

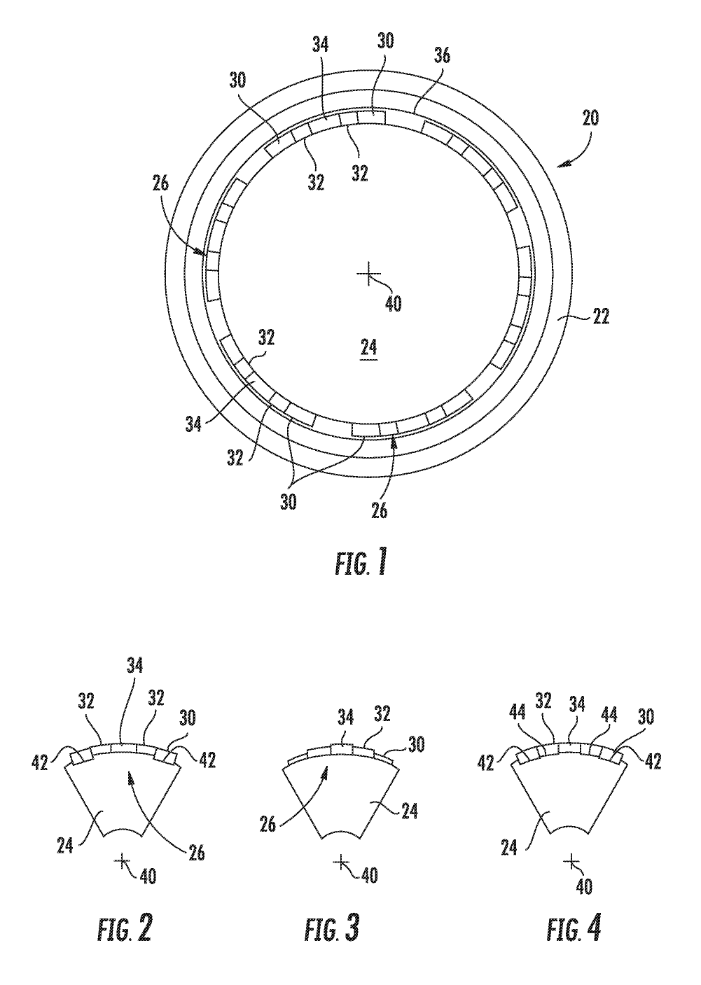

FIG. 3 illustrates an example embodiment in which the outer surfaces of the magnet segments are not equally spaced from the center 40 of the rotatable body 24. In this example, the third magnet segment 34 has the largest or greatest magnet thickness and the outer surface of the third magnet segment 34 is spaced further from the center 40 than the outer surfaces of the first magnet segments 30 and the second magnet segments 32, respectively. Another feature of the example of FIG. 3 is that the magnet thickness of the first magnet segments 30 is smaller than the magnet thickness of the second magnet segments 32, which is smaller than the magnet thickness of the third magnet segment 34.

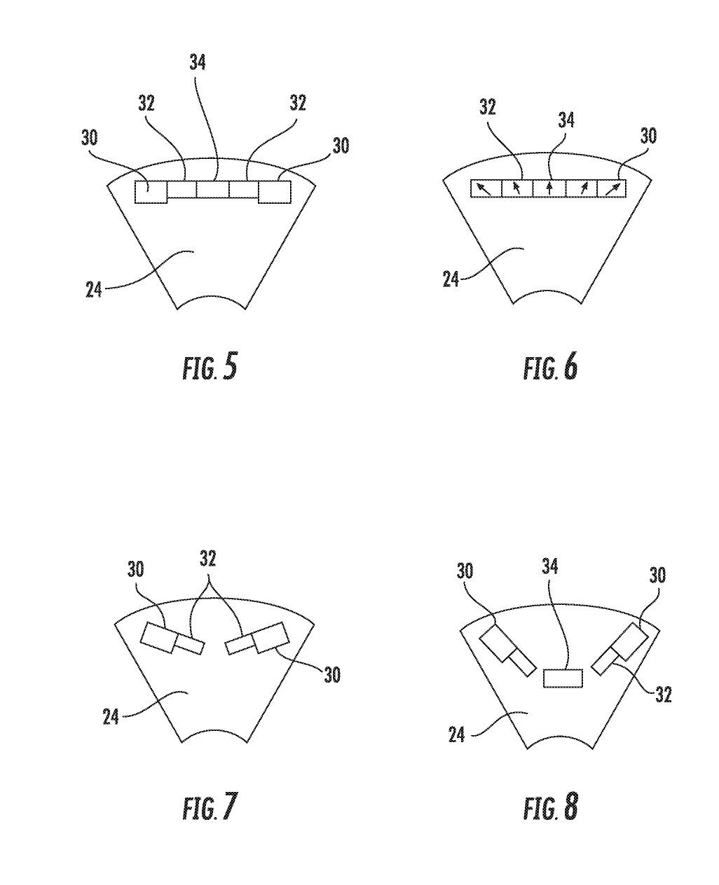

FIG. 4 illustrates another example arrangement in which the outer surfaces of the magnet segments are equally spaced from the center 40 of the rotatable body 24. In this example, recesses 42 are configured to receive a portion of the first magnet segments 30 and recesses 44 are configured to receive a portion of the second magnet segments 32.

FIG. 5 illustrates another example embodiment in which the magnet segments are supported internally on the rotatable body 24. In this example, the first magnet segments 30 have a greater thickness than the other magnet segments. The magnet segments are also arranged in a linear fashion in this example.

FIG. 6 illustrates another example embodiment in which the magnet segments are supported internally on the rotatable body 24. In this example, the different magnetic characteristics comprise different magnetization directions. The third magnet segment 34 has a magnetization orientation represented by the arrow in that segment in the drawing. The second magnet segments 32 each have a magnetization direction that is at an oblique angle relative to that of the third magnet segment 34. The first magnet segments 30 also have respective magnetization directions that are at an oblique angle relative to the magnetization direction of the third magnet segment 34. In this example, the magnetization direction of the second magnet segments 34 is different than that of the first magnet segments 30. Different magnetization directions among the magnet segments of each pole affects the air gap flux profile.

FIG. 7 illustrates another example arrangement of magnet segments supported internally on the rotatable body 24. This example includes first magnet segments 30 and second magnet segments 32. The magnetic characteristic in this example comprises at least the magnet thickness.

FIG. 8 illustrates another example arrangement in which the magnet segments are supported internally on the rotatable body 24.

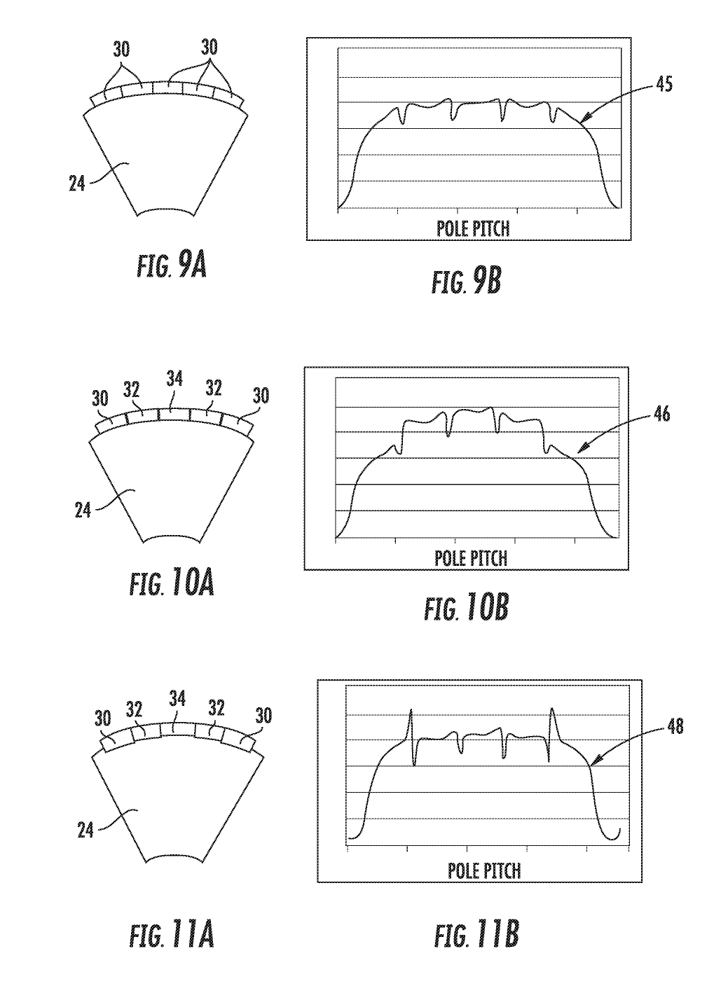

As mentioned above, various magnetic characteristics and various arrangements of the magnet segments allows for customizing the air gap flux density shape or flux profile, which provides greater flexibility for electric machine manufacturers. FIG. 9A shows an example pole configuration in which the magnet segments are arranged with all segments having the same MGOe and the same size. A resulting or corresponding flux profile 45 is shown in FIG. 9B.

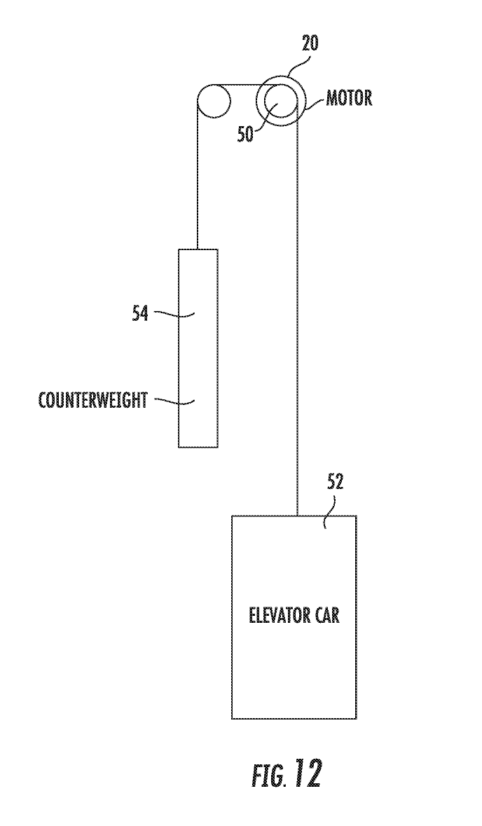

FIG. 10A shows a pole having a different arrangement of magnet segments compared to that of FIG. 9A. In this example, the magnet segment 34 has the highest MGOe of the magnet segments, the magnet segments 32 have the next highest MGOe, and the magnet segments 30 have the lowest MGOe. All magnet segments in this example embodiment have the same size. With such an arrangement, the air gap flux density shape is as shown at 46 in FIG. 10B.

Comparing FIGS. 9B and 10B shows how selecting magnet segments having a different MGOe changes the flux profile.

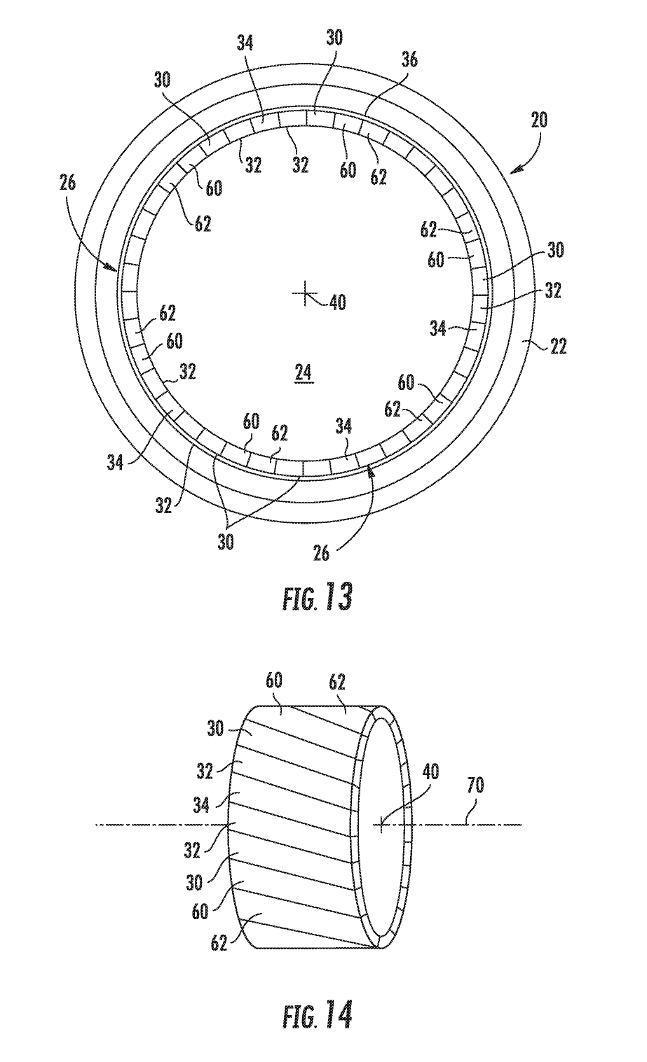

FIG. 11A shows another example pole configuration. In this case the magnet segments 30 are the weakest, the magnet segments 32 are stronger than the magnet segments 30, and the magnet segment 34 is the strongest. The sizes of the magnet segments are different in this instance. The magnet segments 30 are the largest. The magnet segments 32 are smaller than the magnet segments 30 and larger than the magnet segment 34. Even though the relative strengths are similarly arranged to those in the example of FIG. 10A, the different magnet segment sizes alters the flux profile. FIG. 11B shows the corresponding air gap flux density shape 48 for the pole configuration of FIG. 11A.

Comparing FIGS. 10B and 11B shows how selecting magnet segments having a different size affects the flux profile.

FIG. 12 illustrates an example use of an electric machine 20 designed according to an embodiment of this invention. In this example, the electric machine 20 operates as a motor for driving a traction sheave 50 to control movement of an elevator car 52 and counterweight 54 in a known manner. In some example embodiments, the elevator system is configured such that the machine 20 operates as a generator in a regenerative mode of the elevator system.

FIG. 13 illustrates another example arrangement of magnet segments. In this example, the segments that establish the poles 26 collectively extend around an entire circumference of the rotatable body 24. Magnet segments 60 and 62 have magnetization directions oriented to establish magnetic spacing between the poles 26 even though the magnet segments of adjacent poles (i.e., the magnet segments 60 and 62) are not spaced from each other. In one such embodiment the magnet segments are arranged in a Halbach array to control the magnetic field of each of the poles 26. The magnetic characteristics of the respective magnet segments 30, 32 and 34 that influence the magnetic flux of the poles in this example embodiment includes the magnetization direction of the magnet segments.

FIG. 14 illustrates a feature of some embodiments. The magnet segments 30, 32, 34, 60 and 62 have a length in an axial direction of the rotatable body 24. In this example, the magnet segments are at least partially oriented at an oblique angle relative to the axis of rotation 70, which is coincident with the center 40. As can be appreciated from the drawing the magnet segments are skewed along the axial direction and arranged in a spiraling pattern about the circumference of the rotatable body 24.

A variety of embodiments are illustrated in the drawings and discussed above. The different features of each embodiment are not limited to just the particular example embodiments. Different combinations of one or more of those features are possible to realize additional or different embodiments. For example, it is possible to vary any or all of the MGOe, the magnetization direction, and the size of the magnet segments and to have the largest or strongest magnet segments located anywhere within the pole configuration. Additionally, the rotor or rotatable body 24 is shown inside the stator or stationary body 22 in the example of FIG. 1. That orientation could be reversed with the magnet poles 26 on the outer of the two bodies.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

We claim:

1. A machine, comprising:
a rotatable body; and
a plurality of magnet poles supported by the rotatable body, each of the plurality of magnet poles comprising a plurality of magnet segments, a first magnet segment of each of the magnet poles having a first magnetic characteristic that affects a magnetic flux associated with the respective magnet pole in a first way, a second magnet segment of each of the magnet poles having a second magnetic characteristic that affects the magnetic flux associated with the respective magnet pole in a second way, the first magnetic characteristic being different than the second magnetic characteristic, the first way being different than the second way.

2. The machine of claim 1, wherein
the first magnetic characteristic comprises a first magnet strength; and
the second magnetic characteristic comprises a second magnet strength.

3. The machine of claim 2, wherein
the first magnetic characteristic comprises a first magnet thickness; and
the second magnetic characteristic comprises a second magnet thickness.

4. The machine of claim 2, wherein
the first magnet strength is greater than the second magnet strength; and
the first way that the first magnet strength affects the magnetic flux comprises establishing a first magnetic flux density at a location of the first magnet segment;
the second way that the second magnet strength affects the magnetic flux comprises establishing a second magnetic flux density at a location of the second magnet segment; and
the first magnetic flux density is greater than the second magnetic flux density.

5. The machine of claim 1, wherein
the first magnetic characteristic comprises a first magnet thickness;
the second magnetic characteristic comprises a second magnet thickness; and
the first magnet thickness is greater than the second magnet thickness.

6. The machine of claim 5, wherein
the magnet segments are supported on an exterior of the rotatable body;
the rotatable body includes at least one recess configured to receive a portion of the first magnet segment; and
an outer surface of the first and second magnet segments are equally spaced from a center of the rotatable body.

7. The machine of claim 5, wherein
the magnet segments are supported on an exterior of the rotatable body; and
an outer surface of the first and second magnet segments, respectively, are at different distances from a center of the rotatable body.

8. The machine of claim 1, wherein the magnet segments are received at least partially within the rotatable body.

9. The machine of claim 1, wherein
each magnet pole comprises a third magnet segment having a third magnetic characteristic that affects a magnetic flux associated with the corresponding magnet pole in a third way;
the third magnetic characteristic is different than the first and second magnetic characteristics, respectively; and
the third way is different than the first and second ways, respectively.

10. The machine of claim 1, wherein
the machine comprises an electric motor having a stator and a rotor; and
the rotatable body is the rotor of the electric motor.

11. The machine of claim 1, wherein
the first magnetic characteristic comprises a first magnetization direction; and
the second magnetic characteristic comprises a second magnetization direction.

12. The machine of claim 1, wherein
the first magnetic characteristic comprises at least two of a first magnet strength, a first magnet thickness and a first magnetization direction; and
the second magnetic characteristic comprises at least two of a second magnet strength, a second magnet thickness and a second magnetization direction.

13. The machine of claim 1, wherein
the rotatable body has an axis of rotation; and
the magnet segments are at least partially oriented at an oblique angle relative to the axis of rotation.

14. The machine of claim 1, wherein
the magnet segments collectively extend around an entire circumference of the rotatable body;
the first and second magnetic characteristics respectively comprise a magnetization direction; and
at least some of the magnetization directions are arranged to establish distinct poles of opposite and alternating polarity about the circumference.

15. A method of making a machine including a plurality of magnet poles on a rotatable body, each of the magnet poles including a plurality of magnet segments, the method comprising
situating the plurality of magnet segments of each of the plurality of magnet poles on the rotatable body so that a first magnet segment of each of the magnet poles has a first magnetic characteristic that affects a magnetic flux associated with the respective magnet pole in a first way and a second magnet segment of each of the magnet poles has a second magnetic characteristic that affects the magnetic flux associated with the respective magnet pole in a second way,
wherein the first magnetic characteristic is different than the second magnetic characteristic and the first way is different than the second way.

16. The method of claim 15, wherein
the first magnetic characteristic comprises a first magnet strength; and
the second magnetic characteristic comprises a second magnet strength.

17. The method of claim 15, wherein
the first magnetic characteristic comprises a first magnet thickness; and
the second magnetic characteristic comprises a second magnet thickness.

18. The method of claim 15, wherein
the first magnetic characteristic comprises a first magnetization direction; and
the second magnetic characteristic comprises a second magnetization direction.

19. The method of claim 15, wherein
the first magnetic characteristic comprises at least two of a first magnet strength, a first magnet thickness and a first magnetization direction; and
the second magnetic characteristic comprises at least two of a second magnet strength, a second magnet thickness and a second magnetization direction.

20. The method of claim 15, wherein
the first way that the first magnetic characteristic affects the magnetic flux comprises establishing a first magnetic flux density at a location of the first magnet segment;
the second way that the second magnetic characteristic affects the magnetic flux comprises establishing a second magnetic flux density at a location of the second magnet segment; and
the first magnetic flux density is greater than the second magnetic flux density.
